(19) United States
(12) Patent Application Publication
(10) Pub. No.: US 2023/0222384 A1
(43) Pub. Date: Jul. 13, 2023

(54) METHODS FOR SMART GAS STORAGE OPTIMIZATION AND INTERNET OF THINGS SYSTEMS THEREOF

(71) Applicant: CHENGDU QINCHUAN IOT TECHNOLOGY CO., LTD., Chengdu (CN)

(72) Inventors: Zehua SHAO, Chengdu (CN); Bin LIU, Chengdu (CN); Junyan ZHOU, Chengdu (CN); Yaqiang QUAN, Chengdu (CN); Xiaojun WEI, Chengdu (CN)

(73) Assignee: CHENGDU QINCHUAN IOT TECHNOLOGY CO., LTD., Chengdu (CN)

(21) Appl. No.: 18/174,640

(22) Filed: Feb. 26, 2023

(30) Foreign Application Priority Data
Dec. 16, 2022 (CN) 202211618598.1

(51) Int. Cl. G06N 20/00; G16Y 20/30

(52) U.S. Cl. CPC G06N 20/00; G16Y 20/30

(57) ABSTRACT

The present disclosure provides a method for smart gas storage optimization and an Internet of Things system. The method is implemented based on an Internet of Things system for smart gas storage optimization. The Internet of Things system includes a smart gas management platform, a smart gas sensor network platform and a smart gas object platform that interact in sequence. The method is executed by the smart gas management platform. The method includes obtaining gas supply data and historical gas usage data of a target area through the smart gas sensor network platform; predicting future gas usage data of the target area based on the historical gas usage data; determining gas storage demand data of the target area based on the future gas usage data and the gas supply data; and determining a gas storage optimization method of the target area based on the gas storage demand data.

### CROSS-REFERENCE TO RELATED APPLICATIONS

This application claims priority to Chinese Patent Application No. 202211618598.1, filed on Dec. 16, 2022, the entire contents of which are incorporated herein by reference.

### TECHNOLOGY FIELD

The present disclosure relates to the field of gas storage technology, and in particular, to a method and an Internet of Things system for smart gas storage optimization.

### BACKGROUND

Seasonal and diurnal fluctuations in natural gas usage may create an imbalance between gas supply and demand. To supply gas to users safely, smoothly, and reliably, natural gas reserves are needed. That is, the surplus natural gas in a gas transmission system is stored near a user at low peak of gas usage to supplement the shortage of gas supply at peak of gas usage or to ensure continuous gas supply in case of failure on the gas transmission system.

Therefore, it is desirable to propose a method and an Internet of Things system for smart gas storage optimization that can reduce a storage cost of gas while ensuring a normal operation of the transmission and supply system.

### SUMMARY

According to one or more embodiments of the present disclosure, a method for smart gas storage optimization is provided. The method for smart gas storage optimization is implemented based on a smart gas storage optimization Internet of Things system. The Internet of Things system includes a smart gas management platform, a smart gas sensor network platform, and a smart gas object platform that interact in sequence. The method is executed by the smart gas management platform. The method includes: obtaining gas supply data and historical gas usage data of a target area through the smart gas sensor network platform based on the smart gas object platform; predicting future gas usage data of the target area based on the historical gas usage data; determining gas storage demand data of the target area based on the future gas usage data and the gas supply data; and determining a gas storage optimization method of the target area based on the gas storage demand data.

According to one or more embodiments of the present disclosure, an Internet of Things system for smart gas storage optimization is provided. The Internet of Things system includes a smart gas management platform, a smart gas sensor network platform, and a smart gas object platform that interact in sequence. The smart gas management platform is configured to obtain gas supply data and historical gas usage data of a target area through the smart gas sensor network platform based on the smart gas object platform; predict future gas usage data of the target area based on the historical gas usage data; determine gas storage demand data of the target area based on the future gas usage data and the gas supply data, and determine a gas storage optimization method of the target area based on the gas storage demand data.

According to one or more embodiments of the present disclosure, a non-transitory computer-readable storage medium storing computer instructions is stored, when the computer instructions are executed by a processor, the computer executes the above method for smart gas storage optimization.

### BRIEF DESCRIPTION OF THE DRAWINGS

The present disclosure is further illustrated in terms of exemplary embodiments. These exemplary embodiments are described in detail according to the drawings. These embodiments are non-limiting exemplary embodiments, in which like reference numerals represent similar structures, wherein:

FIG. 1 is a schematic diagram illustrating a platform structure of an Internet of Things system for smart gas storage optimization according to some embodiments of the present disclosure;

FIG. 2 is an exemplary flowchart illustrating a method for smart gas storage optimization according to some embodiments of the present disclosure;

FIG. 3 is a schematic diagram illustrating a process for determining future gas usage data based on a first prediction model according to some embodiments of the present disclosure;

FIG. 4 is a schematic diagram illustrating a process for determining accuracy of future gas usage data based on the first prediction model according to some further embodiments of the present disclosure;

FIG. 5 is a schematic diagram illustrating a process for determining a gas storage optimization method based on a second prediction model according to some embodiments of the present disclosure;

FIG. 6 is a schematic diagram of decomposing historical gas usage data according to some embodiments of the present disclosure.

### DETAILED DESCRIPTION

To more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that the “system,” “device,” “unit,” and/or “module” used herein are one method to distinguish different components, elements, parts, sections, or assemblies of different levels. However, if other words can achieve the same purpose, the words may be replaced by other expressions.

As used in the disclosure and the appended claims, the singular forms “a,” “an,” and “the” include plural referents unless the content clearly dictates otherwise; the plural forms may be intended to include singular forms as well. In general, the terms “comprise,” “comprises,” and/or “comprising,” “include,” “includes,” and/or “including,” merely prompt to include steps and elements that have been clearly identified, and these steps and elements do not constitute an exclusive listing. The methods or devices may further include other steps or elements.

The flowcharts used in the present disclosure illustrate operation that the system implements according to the embodiment of the present disclosure. It should be understood that the foregoing or following operation may not necessarily be performed exactly in order. Instead, the operation may be processed in reverse order or simultaneously. Besides, one or more other operations may be added to these processes, or one or more operations may be removed from these processes.

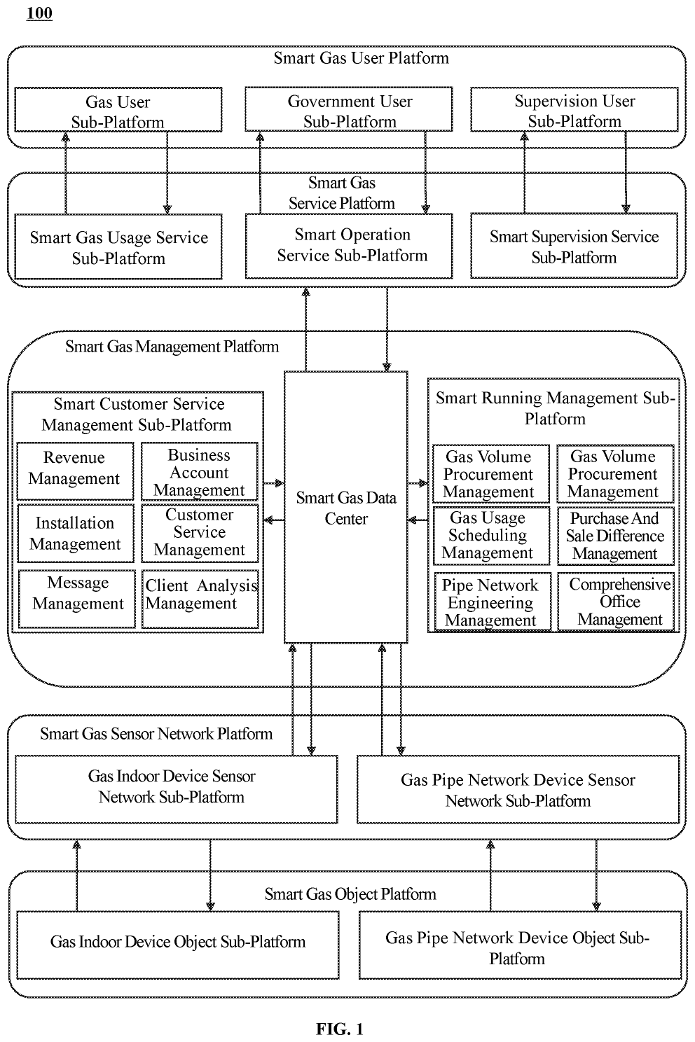

FIG. 1 is a schematic diagram illustrating a platform structure of an Internet of Things system for smart gas storage optimization according to some embodiments of the present disclosure. As shown in FIG. 1, the Internet of Things system 100 for smart gas storage optimization may include a smart gas user platform, a smart gas service platform, a smart gas management platform, a smart gas sensor network platform, and a smart gas object platform.

In some embodiments, the Internet of Things system 100 for smart gas storage optimization may be applied to a variety of application scenarios such as gas storage optimization. In some embodiments, the Internet of Things system 100 for smart gas storage optimization may obtain gas supply data and historical gas usage data of a target area. Future gas usage data of the target area may be predicted based on historical gas usage data. Gas storage demand data of the target area may be determined based on the future gas usage data and the gas supply data. A gas storage optimization method of the target area may be determined based on the gas storage demand data.

The various application scenarios for gas storage optimization may include gas management in a newly developed neighborhood, an area of a city, etc. It should be noted that the above scenarios are merely examples and do not limit the specific application scenarios of the Internet of Things system 100 for smart gas storage optimization, and those skilled in the art may apply the Internet of Things system 100 for smart gas storage optimization to any other suitable scenarios based on the content disclosed of the embodiment.

The following is a specific description of the Internet of Things System 100 for smart gas storage optimization.

The smart gas user platform may be a user-oriented service interface configured as a terminal device. In some embodiments, the smart gas user platform may include a gas user sub-platform, a government user sub-platform, and a supervisory user sub-platform.

The gas user sub-platform may be a sub-platform for a gas user. The gas user is a consumer of gas. For example, the gas user may be a user who actually uses gas. In some embodiments, the gas user sub-platform may correspond to and interact with a smart gas usage service sub-platform. For example, the gas user sub-platform may obtain services of safety gas usage from the smart gas usage service sub-platform.

The government user sub-platform may be a sub-platform that targets a government user and provides gas operation-related data to the government user. In some embodiments, the government user sub-platform may correspond to and interact with a smart operation service sub-platform. For example, the government user sub-platform may obtain services for gas operation from the smart operation service sub-platform.

The supervisory user sub-platform may be a sub-platform that targets a supervision user and supervises the operation of the whole Internet of Things system. The supervision user is a user of a security department. In some embodiments, the supervision user sub-platform may correspond to and interact with a smart supervision service sub-platform. For example, the supervision user sub-platform may obtain services of safety supervision demands from the smart supervision service sub-platform.

In some embodiments, the smart gas user platform may receive information from a user. For example, the smart gas user platform may receive a running management information query instruction of a gas gate station from a gas user. In some embodiments, the smart gas user platform may feed information back to the user. For example, the smart gas user platform may feed the running management information of the gas gate station back to the gas user.

In some embodiments, the smart gas user platform may interact with the smart gas service platform. For example, the gas user sub-platform may send the running management information query instruction of the gas gate station to the smart gas usage service sub-platform. As another example, the gas user sub-platform may receive the running management information of the gas gate station uploaded by the smart gas usage service sub-platform.

The smart gas service platform may be a platform configured to receive and transmit data and/or information. In some embodiments, the smart gas service platform may include the smart gas usage service sub-platform, the smart operation service sub-platform, and the smart supervision service sub-platform.

In some embodiments, the smart gas usage service sub-platform may correspond to the gas user sub-platform to provide gas users with gas device-related information. The smart operation service sub-platform may correspond to the government user sub-platform and provide gas operation-related information for the government user. The smart supervision service sub-platform may correspond to the supervision user sub-platform to provide supervision management-related information for supervision users.

In some embodiments, the smart gas service platform may interact with the smart gas management platform. For example, the smart gas usage service sub-platform may send the running management information query instruction of the gas gate station to a smart gas data center. As another example, the smart gas usage service sub-platform may receive the running management information of the gas gate station uploaded by the smart gas data center.

The smart gas management platform may refer to an Internet of Things platform that arranges and coordinates the connection and collaboration between various functioning platforms to provide perception management and control management. In some embodiments, the smart gas management platform may include a smart customer service management sub-platform, a smart running management sub-platform, and a smart gas data center. In some embodiments, the smart customer service management sub-platform and the smart running management sub-platform are independent mutually. The smart customer service management sub-platform and the smart running management sub-platform are data usage platforms and do not store data. In some embodiments, the smart gas data center aggregates and stores all operation data of the system. In some embodiments, the smart customer service management sub-platform and the smart running management sub-platform interact with the smart gas data center bidirectionally. For example, the smart customer service management sub-platform and the smart running management sub-platform may obtain relevant data from the smart gas data center, respectively. As another example, the smart customer service management sub-platform and the smart running management sub-platform may send management operation running data to the smart gas data center, respectively.

In some embodiments, modules of the smart customer service management sub-platform may include a revenue management module, a business account management module, an installation management module, a customer service management module, a message management module, and a client analysis management module. In some embodiments, modules of the smart running management sub-platform may include a gas volume procurement management module, a gas volume reserve management module, a gas usage scheduling management module, a purchase and sale difference management module, a pipe network engineering management module, and a comprehensive office management module. The gas volume reserve management module may be configured to store gas volume reserve information. The gas usage scheduling management module may be configured for gas distribution, regulation, and supply of different areas and different pipe network nodes.

In some embodiments, the smart gas management platform may interact with the smart gas service platform and the smart gas sensor network platform, respectively. The smart gas management platform interacts with the smart gas service platform and the smart gas sensor network platform, respectively, through the smart gas data center. For example, the smart gas data center may receive running management information query instructions of the gas gate station sent by the smart gas service platform. As another example, the smart gas data center may send instructions of obtaining gas device-related data to the smart gas sensor network platform. As another example, the smart gas data center may receive the gas device-related data uploaded by the smart gas sensor network platform.

In some embodiments, the smart gas data center may send received gas device-related data to the smart running management sub-platform for processing and analyzing. The smart running management sub-platform may send analyzed and processed data to the smart gas data center. The smart gas data center may send aggregated and processed data to the smart gas service platform. The data may include the running management information of the gas gate station (e.g., supply amount of gas storage, supply method of gas storage, supply time of gas storage).

The smart gas sensor network platform may be a platform that enables interaction between the smart gas management platform and the smart gas object platform, which is configured as a communication network and a gateway. In some embodiments, the smart gas sensor network platform may include a gas indoor device sensor network sub-platform and a gas pipe network device sensor network sub-platform.

In some embodiments, the gas indoor device sensor network sub-platform may mutually correspond to the gas indoor device object sub-platform. The gas indoor device sensor network sub-platform may receive related data of the gas indoor device uploaded by the gas indoor device object sub-platform.

In some embodiments, the gas pipe network device sensor network sub-platform may mutually correspond to the gas pipe network device object sub-platform. The gas pipe network device sensor network sub-platform may receive the related data of the pipe network device uploaded by the gas pipe network device object sub-platform.

In some embodiments, the smart gas sensor network platform may interact with the smart gas object platform. For example, the smart gas sensor network platform may receive related data of the gas indoor device and/or related data of the pipe network device uploaded by the smart gas object platform. As another example, the smart gas sensor network platform may send the instructions of obtaining the related data of the gas indoor device and/or instructions of obtaining the related data of the pipe network device to the smart gas object platform.

The smart gas object platform may be a function platform for perception information generation and final execution of control information, which is configured as various gas devices. The gas devices may include indoor devices and pipe network devices. For example, an indoor device may be a gas terminal (e.g., a gas meter) of a gas user. As another example, the pipe network device may be a certain gas gate station, each section of gas transmission pipelines, a gas valve control device, etc. In some embodiments, the smart gas object platform may include a gas indoor device object sub-platform and a gas pipe network device object sub-platform.

In some embodiments, the gas indoor device object sub-platform may mutually correspond to the gas indoor device sensor network sub-platform. The gas indoor device object sub-platform may upload the related data of the gas indoor device to the smart gas data center through the gas indoor device sensor network sub-platform.

In some embodiments, the gas pipe network device object sub-platform may correspond to the gas pipe network device sensor network sub-platform. The gas pipe network device object sub-platform may upload the related data of the gas pipe network device to the smart gas data center through the gas pipe network device sensor network sub-platform.

In some embodiments, the smart gas object platform may interact with the smart gas sensor network platform. For example, the smart gas object platform may receive instructions of obtaining the related data of the gas device sent by the smart gas sensor network platform. As another example, the smart gas object platform may upload the related data of the gas device to a corresponding gas sensor network sub-platform.

It should be noted that the smart gas user platform in the embodiment may be a desktop computer, a tablet computer, a laptop computer, a neighborhood phone, or other electronic devices capable of data processing as well as data communication, which is not limited herein. It should be understood that the data processing mentioned in the embodiment may be processed by a processor of a server, and the data stored in the server may all be stored on a storage device of the server, such as a hard disk and other memories. In a specific application, the smart gas sensor network platform may use a plurality of groups of gateway servers, or a plurality of groups of smart routers, which is not limited herein. It should be understood that the data processing mentioned in the embodiment may be processed by a processor of a gateway server, and the data stored in the gateway server may all be stored on the storage device of the gateway server, such as a hard disk, a solid state disk (SSD), and other memories.

In some embodiments of the present disclosure, a smart gas storage optimization is implemented through function architecture of an Internet of Things with five platforms, which can complete a closed loop of information flow, thereby making information processing of the Internet of Things smoother and more efficient.

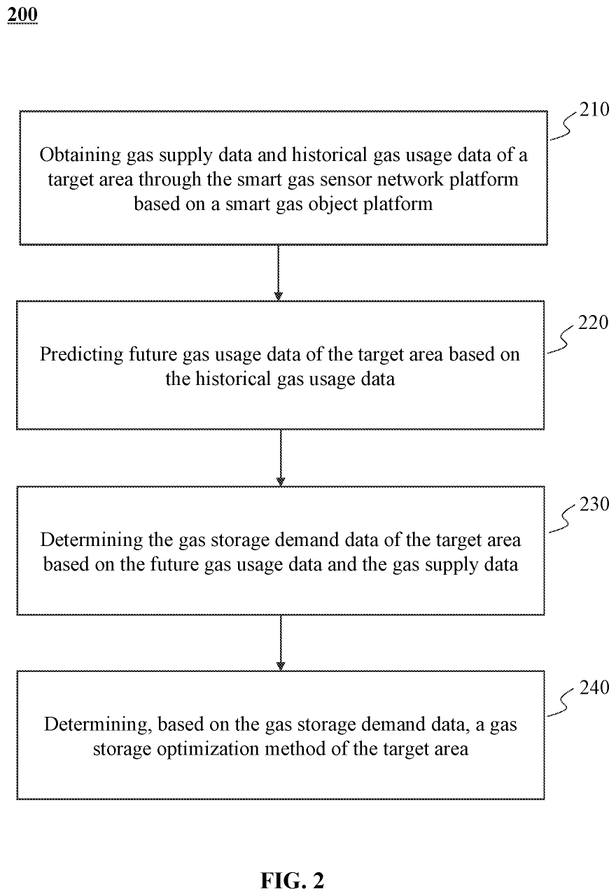

FIG. 2 is an exemplary flowchart illustrating a method for smart gas storage optimization according to some embodiments of the present disclosure. In some embodiments, a process 200 may be performed by the smart gas management platform. As shown in FIG. 2, the process 200 includes the following steps.

Step 210, obtaining gas supply data and historical gas usage data of a target area through the smart gas sensor network platform based on a smart gas object platform.

The target area is a management area corresponding to the smart gas management platform. For example, the target area may be a neighborhood. As another example, the target area may be a city.

The gas supply data refers to a gas supply amount of the gas pipeline per unit time in the target area. For example, the gas supply data may be that a daily gas supply amount of a gas pipeline in a neighborhood is A m³. The gas supply data does not include supply amount of gas storage.

In some embodiments, the smart gas management platform may obtain gas supply data based on historical statistical data of the gas gate station. For example, since the gas supply data does not change significantly from day to day, the smart gas management platform may take the fixed value obtained by averaging the statistical data of the gas gate in the past several days as the daily gas supply data.

The historical gas usage data is a sequence composed of multiple gas usage data corresponding to a historical time sequence in the target area. For example, the historical gas usage data may be a sequence composed of daily gas usage data for the past 5 years.

In some embodiments, the smart gas management platform may obtain historical gas usage data based on the historical statistical data of the gas gate station.

Step 220, predicting future gas usage data of the target area based on the historical gas usage data.

The future gas usage data is a gas usage amount in the target area over a future time period. The length of the future time period may be a default value, an empirical value, a human preset value, or the like, or any combination thereof. For example, the future gas usage data may be a gas usage amount for a certain day/week/month/quarter in the future.

In some embodiments, the smart gas management platform may use the gas usage amount for a time period corresponding to a future time period in the past year as the future gas usage data. In some embodiments, the smart gas management platform may take the average of the gas usage amount for the time period corresponding to the future time period over the past many years as the future gas usage data.

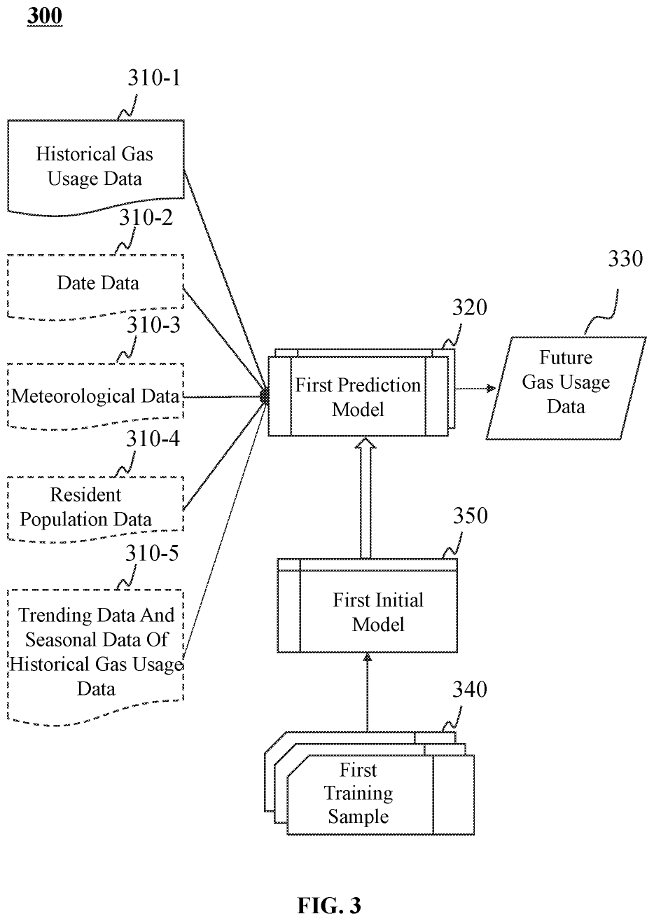

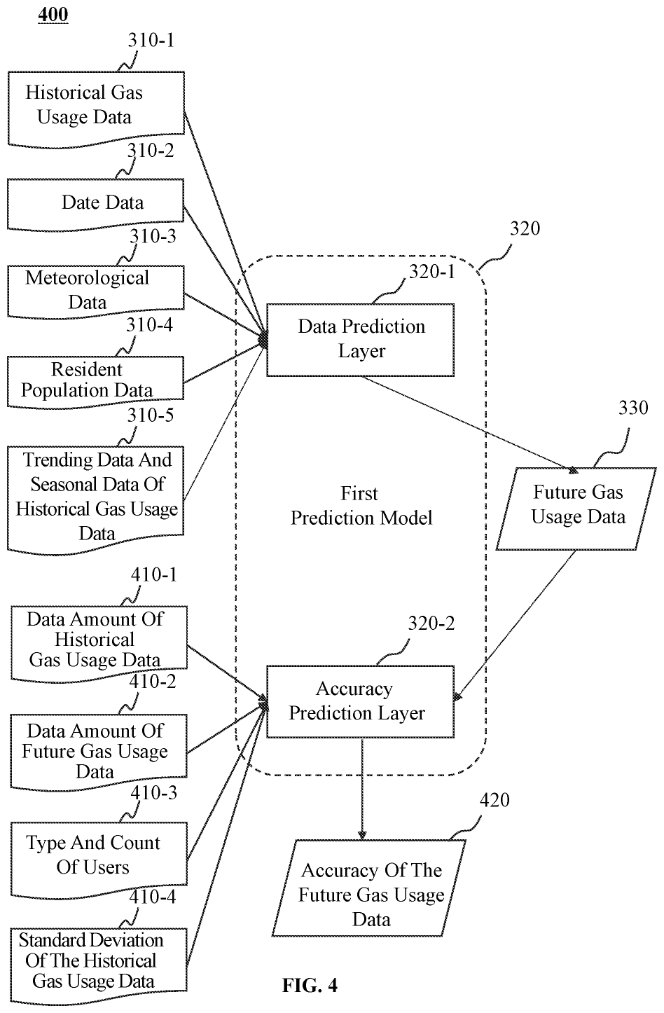

In some embodiments, the smart gas management platform may further obtain the future gas usage data through a first prediction model based on historical gas usage data. More descriptions of obtaining the future gas usage data through the first prediction model may be found in FIG. 3 and FIG. 4 and the related descriptions thereof.

Step 230, determining the gas storage demand data of the target area based on the future gas usage data and the gas supply data.

The gas storage demand data is an amount of storage gas needed in the target area for a future time period. For example, the gas demand data may be the amount of gas storage needed in a neighborhood for a certain week in the future as C m³.

In some embodiments, the smart gas management platform may manually set the gas storage demand data based on experience.

In some embodiments, the smart gas management platform may determine the gas storage demand data of the target area based on a difference between the future gas usage data and the gas supply data.

For example, the gas storage demand data of a neighborhood for a future week may be obtained by subtracting the gas supply data of the neighborhood for the future week from the gas usage data of the neighborhood for the future week.

In some embodiments of the present disclosure, accurate gas storage demand data may be obtained by determining the gas storage demand data of the target area based on the difference between the future gas usage data and the gas supply data.

In some embodiments, the smart gas management platform may obtain the gas difference data based on a difference between the future gas usage data and the gas supply data, and determine the gas storage demand data of the target area based on the gas difference data and a reserve coefficient.

For example, the gas demand data of a neighborhood for a next month may be obtained by following calculation. The gas supply data for each day is respectively subtracted from the future gas usage data of the neighborhood for each day in the next month to obtain the difference for the day. The difference greater than 0 m³ is determined as daily gas difference data of the neighborhood for the future month. The difference less than or equal to 0 m³ is discarded, i.e., when the future gas usage data is less than the gas supply data, there is no need to store gas. Finally, the daily gas difference data is multiplied by the daily reserve coefficient for the next month and summed to obtain the gas storage demand data of the neighborhood for the next month.

In some embodiments, the reserve coefficient is related to seasonal data of the future gas usage data and the accuracy of the future gas usage data. The greater the seasonal data of the future gas usage data is and the greater the accuracy of the future gas usage data is, the greater the reserve coefficient may be. In particular, the method of confirming the seasonal data of the future gas usage data is similar to that of the seasonal data of historical gas usage data. More descriptions of the seasonal data of historical gas usage data and the accuracy of future gas usage data may be found in FIGS. 2-4 and the related descriptions thereof. For example, when gas storage demand data is predicted from Aug. 1, 2030 to Dec. 31, 2030, the gas usage amount on December 1 is increased compared to the gas usage amount on August 1 due to seasonal reasons, the corresponding seasonal data on December 1 is larger than the seasonal data on August 1, then the reserve coefficient on December 1 is larger than the reserve coefficient on August 1. As another example, when storage demand data is predicted from Aug. 1, 2030 to Dec. 31, 2030, if the accuracy of the future gas usage data on December 1 is greater than the accuracy of the future gas usage data on August 1, then the reserve coefficient on December 1 is greater than the reserve coefficient on August 1.

In some embodiments of the present disclosure, the difference between the future gas usage data and the gas supply data is used to obtain the gas difference data, and the gas difference data is multiplied by a reserve coefficient to obtain the gas storage demand data, which can consider different demands for gas in different seasons and the accuracy of the future gas usage data, and make the final obtained gas storage demand more accurate.

Step 240, determining, based on the gas storage demand data, a gas storage optimization method of the target area.

The gas storage optimization method is a method related to gas storage. For example, the gas storage optimization method may include the supply amount of gas storage, the supply method of gas storage, the supply time of gas storage, etc.

In some embodiments, the smart gas management platform may manually determine the gas storage optimization method based on the gas storage demand data according to experience.

In some embodiments, the smart gas management platform may determine the supply amount of gas storage and a supply method of the target area based on the gas storage demand data, the accuracy of future gas usage data, seasonal data of the historical gas usage data, and the cost per unit of gas storage for at least one storage method.

The accuracy of future gas usage data is a consistent degree between predicted future gas usage data and actual future gas usage data. The accuracy of future gas usage data may be expressed as a real number between 0 and 1. The larger the real number is, the higher the accuracy of the future gas usage data is, and the greater the consistent degree between the predicted future gas usage data and the actual future gas usage data is. More descriptions regarding the accuracy of future gas usage data may be found in FIG. 4 and the related descriptions thereof.

The seasonal data of the historical gas usage data is data reflecting seasonal fluctuations in gas usage amount. For example, the greater the gas usage amount in a certain season is, the greater the seasonal data in the season is.

In some embodiments, the seasonal data of historical gas usage data may be obtained based on the historical gas usage data by using methods, such as classical decomposition, X11 decomposition (X11), seasonal and trend decomposition using loess (STL), etc. More descriptions regarding the seasonal data of the historical gas usage data may be found in FIG. 3 and the related descriptions thereof.

The cost per unit of gas storage for a gas storage method is a cost of storage gas required to store a unit volume of gas using a particular storage method. For example, the cost of storing 1 m³ gas in the form of hydrates is Q yuan.

In some embodiments, the cost per unit of gas storage for a gas storage method may be obtained by querying historical gas storage cost data.

The supply amount of gas storage is an amount of additional gas needed to replenish the gas storage. For example, the supply amount of gas storage may be D m³.

The supply method of gas storage is a method of gas storage to replenish gas. For example, the supply method of gas storage may include gas storage in the form of hydrates, underground gas storage, gas storage in tanks, high-pressure pipeline gas storage, liquefied gas storage, and other methods.

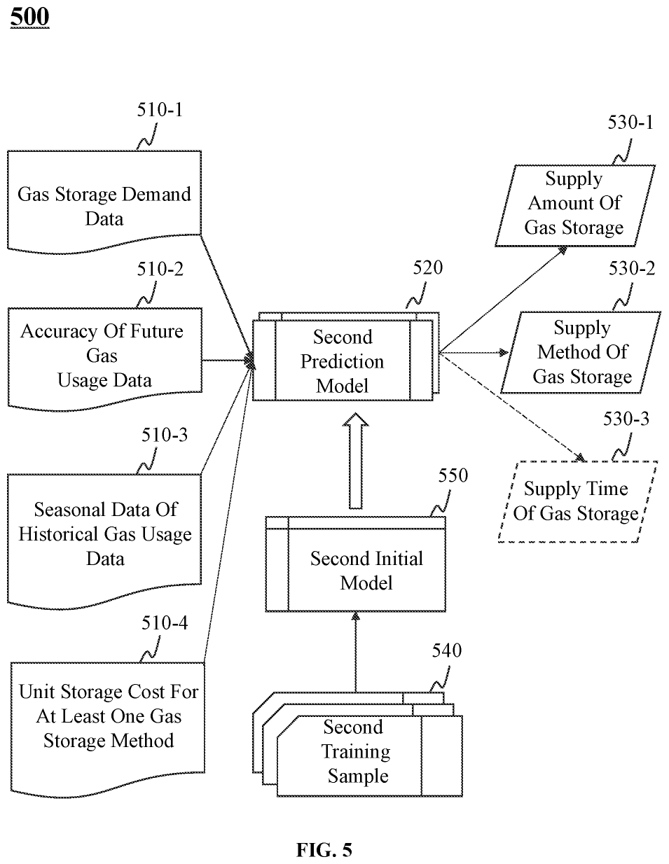

In some embodiments, the smart gas management platform may determine the gas storage supply amount and the gas storage supply method through a second prediction model based on the gas storage demand data, the accuracy of the future gas usage data, the seasonal data of the historical gas usage data, and the cost per unit of gas storage for at least one gas storage method. More descriptions of determining the supply amount of gas storage and the supply method of gas storage through the second prediction model may be found in FIG. 5 and the related descriptions thereof.

In some embodiments of the present disclosure, the supply amount of gas storage and supply method of the target area are determined based on gas storage demand data, the accuracy of future gas usage data, the seasonal data of historical gas usage data, and the cost per unit of gas storage for at least one gas storage method, which can use data from multiple sources as influencing factors to make the final gas storage optimization method more accurate and economical, and help to reduce gas storage cost while ensuring the normal operation of the transmission and supply system.

In some embodiments of the present disclosure, the gas storage demand data is determined based on the future gas usage data and the gas supply data so as to determine a gas storage optimization method, which can make a more rational allocation of gas usage and storage in the target area and reduce the cost of gas storage.

FIG. 3 is a schematic diagram illustrating a process for determining future gas usage data based on a first prediction model according to some embodiments of the present disclosure.

In some embodiments, the smart gas management platform may predict future gas usage data of a target area based on historical gas usage data through a first prediction model. The first prediction model is a machine learning model.

In some embodiments, the first prediction model may be configured to predict the future gas usage data of the target area. The first prediction model may be a machine learning model. For example, the first prediction model may be a Long Short-Term Memory (LSTM) model, a Deep Neural Networks (DNN) model, a Convolutional Neural Networks (CNN) model, a Recurrent Neural Network (RNN) model, or the like, or any combination thereof.

In some embodiments, as shown in FIG. 3, the input of the first prediction model 320 includes historical gas usage data 310-1. More details regarding the historical gas usage data may be found in FIG. 2 and the related descriptions thereof.

In some embodiments, the input of the first prediction model 320 may further include date data 310-2, meteorological data 310-3 of the target area, and resident population data 310-4 of the target area.

Date data 310-2 may refer to attribute data related to a date. For example, date data 310-2 may include date information, seasonal information, and holiday information for the past 5 years.

Meteorological data 310-3 may refer to attribute data related to a meteorological phenomenon. For example, meteorological data 310-3 may include daily average temperature, daily average precipitation, and daily average barometric pressure for the past 5 years.

Resident population data 310-4 may refer to attribute data related to the population. For example, the resident population data may include annual resident population data 310-4 for the past five years.

In some embodiments, the date data 310-2, meteorological data 310-3, and resident population data 310-4 may be obtained through analysis of big data, third-party platforms, or the like. For example, the smart gas management platform may obtain a large data amount through the data of gas operators and network crawling for performing statistics, analysis, and other processing to obtain the date data 310-2, meteorological data 310-3, and resident population data 310-4.

By inputting the date data 310-2, meteorological data 310-3, and resident population data 310-4 into the first prediction model 320, gas usage fluctuations caused by time, weather, and population are included in the calculation, enabling more accurate future gas usage data 330 to be obtained.

In some embodiments, the input of the first prediction model 320 may further include trending data and the seasonal data of historical gas usage data of the target area 310-5.

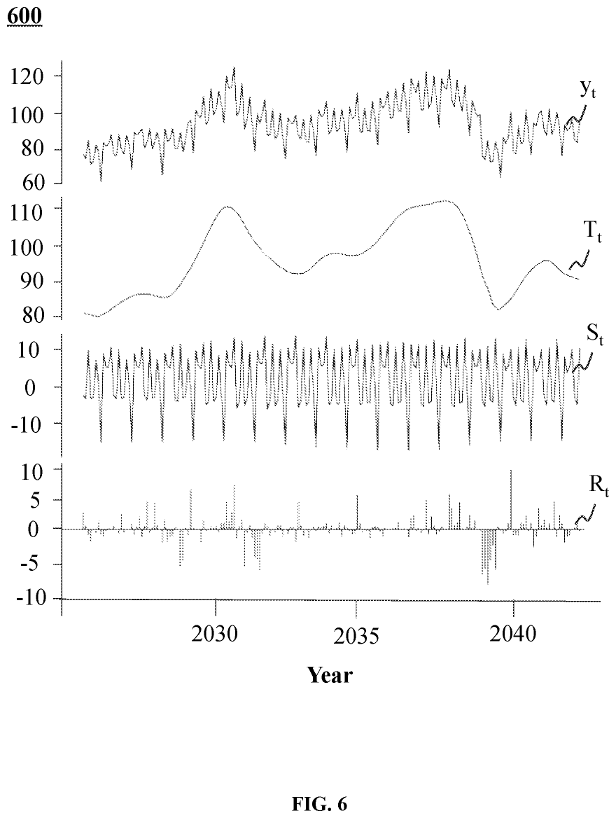

The trending data of historical gas usage data may refer to data reflecting an overall change trend of gas usage. For example, as shown in FIG. 6, the trending data of historical gas usage data may be a vertical coordinate value of the curve Tₜ at the time corresponding to the historical gas usage data. The curve Tₜ composed of trending data may reflect the overall trend of historical gas usage data yₜ, i.e., when yₜ increases with time, Tₜ also increases with time; when yₜ decreases with time, Tₜ also decreases with time.

The seasonal data of historical gas use data may refer to data reflecting seasonal fluctuations in gas usage. For example, as shown in FIG. 6, the seasonal data of historical gas usage data may be a vertical coordinate value of the curve Sₜ at the time corresponding to the historical gas usage data. The greater the gas usage in a certain season is, the greater the seasonal data of historical gas usage data in the season is. The smaller the gas usage in a certain season is, the smaller the seasonal data of historical gas usage data in the season is.

In some embodiments, the trending data and the seasonal data of historical gas usage data may be obtained based on historical gas usage data by decomposition methods. The decomposition methods may include classical time sequence decomposition, X11 decomposition method, STL decomposition method, etc. For example, as shown in a schematic diagram 600 of decomposing historical gas usage data of FIG. 6, the smart gas management platform may decompose the curve yₜ composed of historical gas usage data into the curve Tₜ composed of trending data, the curve Sₜ composed of seasonal data, and the curve Rₜ composed of residual terms, thereby determining the trending data and seasonal data of historical gas usage data 310-5.

The trending data and seasonal data of historical gas usage data are determined as the input of the model. On the one hand, the model may be trained faster, on the other hand, the model's prediction may be more accurate.

The output of the first prediction model 320 may include future gas usage data 330. More details regarding the future gas usage data may be found in FIG. 2 and the related descriptions thereof.

In some embodiments, the prediction model 320 may be obtained by training a plurality of training samples with labels. A plurality of first training samples 340 with labels may be input into a first initial model 350. A loss function is constructed from labels and output results of the first initial model 350, and the parameters of the first initial model 350 are updated iteratively based on the loss function. The model training is completed when the loss function of the first initial model 350 satisfies a preset condition. The preset condition may be the convergence of the loss function, the count of iterations reaching a threshold, etc.

In some embodiments, the first training sample 340 may include sample historical gas usage data. The label may be the future gas usage data corresponding to the sample moment. The sample historical gas usage data may be obtained based on historical data. The label may be determined based on the actual value of the gas usage data at the time after the time sequence corresponding to the sample historical gas usage data, and the future gas usage data is the gas usage data of the historical data. For example, if it is Jan. 1, 2030 at present, the sample historical gas usage data may be the daily gas usage data between Jan. 1, 2025 and Jan. 1, 2028; the label may be the gas usage data between Jan. 1, 2029 and Jan. 31, 2029.

When the input of the first prediction model 320 include the date data 310-2, meteorological data 310-3, and resident population data 310-4, the first training sample 340 may further include sample date data, sample meteorological data, and sample resident population data. The sample date data, the sample meteorological data, and the sample resident population data may be obtained based on historical data.

When the input of the first prediction model 320 includes the trending data and seasonal data of historical gas usage data 310-5, the first training sample 340 may further include trending data and seasonal data of sample historical gas usage data. Therein, the trending data and seasonal data of the sample historical gas usage data may be obtained based on historical data.

In some embodiments of the present disclosure, the smart gas management platform may quickly and accurately predict future gas usage data based on the historical gas usage data using the first prediction model, which can help the smart gas management platform determine an accurate gas storage optimization method. In addition, by inputting date data, meteorological data, resident population data, and/or trending and seasonal data of historical gas usage data, the first prediction model can predict the future gas usage data more accurately.

FIG. 4 is a schematic diagram illustrating a process for determining accuracy of future gas usage data based on the first prediction model according to some further embodiments of the present disclosure.

In some embodiments, the first prediction model 320 may be a neural network model. For example, the first prediction model 320 may be a DNN model, a CNN model, an RNN model, or the like, or any combination thereof. In some embodiments, as shown in FIG. 4, the input of the first prediction model 320 may include the historical gas usage data 310-1, date data 310-2, meteorological data 310-3, resident population data 310-4, and the trending data and seasonal data of historical gas usage data 310-5. The output of the first prediction model 320 may include accuracy of future gas usage data 420.

In some embodiments, the first prediction model 320 may further include a data prediction layer 320-1 and an accuracy prediction layer 320-2.

In some embodiments, the input of the data prediction layer 320-1 may include the historical gas usage data 310-1, the date data 310-2, meteorological data 310-3, the resident population data 310-4, and the trending data and seasonal data of historical gas usage data 310-5. In some embodiments, the output of the data prediction layer 320-1 may include the future gas usage data 330. In some embodiments, the data prediction layer 320-1 may be a CNN.

In some embodiments, the input of the accuracy prediction layer 320-1 may include the future gas usage data 330, the data amount of the historical gas usage data 410-1, the data amount of the future gas usage data 410-2, a type and count of users 410-3, and the standard deviation of the historical gas usage data 410-4. In some embodiments, the output of the accuracy prediction layer 320-1 may include an accuracy of the future gas usage data 420. In some embodiments, the output of the accuracy prediction layer 320-1 may be a DNN.

The data amount is all data of a time span corresponding to the usage data. For example, the data amount may be all historical gas usage data for the past 5 years. For example, data amount of historical gas usage data 410-1 may be historical gas usage data for the past 5 years; data amount of future gas usage data 410-2 may be predicted future gas usage data for the next 1 year.

In some embodiments, the data amount of the historical gas usage data is the data of the past 5 years or the data of the past 3 years, which affects accuracy of the future gas usage data. For example, data amount of historical gas usage data as the data of the past 5 years is more accurate than the data amount of historical gas usage data as the data of the past 3 years in predicting future gas usage data.

In some embodiments, the data amount for predicting future gas usage data is data of one month in the future or data of one quarter in the future, which affects accuracy of the future gas usage data. For example, the data amount for predicting future gas usage data as the data of one month in the future is more accurate than data amount for predicting future gas usage data as the data of one quarter in the future in predicting the future gas usage data.

The type and count of users are the attributes of users and the count of users of each attribute. The attributes of the users may include residential users and industrial and commercial users. For example, the type and count of users may include 3000 residential users and 500 industrial and commercial users, etc.

In some embodiments, the type and count of the user may be obtained through analysis of big data, third-party platforms, or the like. For example, the smart gas management platform may obtain a large data amount through community database and network crawling for performing statistics, analysis, and other processing to obtain the type and count of users 410-3.

The standard deviation of historical gas usage data is a value that may reflect the magnitude of the difference between different historical gas usage values. In some embodiments, the smart gas management platform may calculate the standard deviation based on each historical gas usage value in the historical gas usage data sequence by using a formula for calculating the standard deviation.

In some embodiments, the data prediction layer 320-1 and the accuracy prediction layer 320-2 may be obtained by joint training.

In some embodiments, the sample data for joint training may include the sample historical gas usage data, the sample date data, the sample meteorological data, the sample resident population data, the trending data and seasonal data of sample historical gas usage data, the data amount of sample historical gas usage data, the data amount of sample future gas usage data, the type and count of sample users, the standard deviation of the sample historical gas usage data, and the label may be the accuracy of the sample future gas usage data. The accuracy of the sample future gas usage data may be determined based on the future gas usage data output from data prediction layer 320-1 and the sample future gas usage data, and the sample future gas usage data is the actual value of the future gas usage data among the historical data.

While training, sample historical gas usage data, sample date data, sample meteorological data, sample resident population data, and trending data and seasonal data of sample historical gas usage data are input into the data prediction layer 320-1 to obtain the future gas usage data output from the data prediction layer. The future gas usage data outputted by the data prediction layer as training sample data, the data amount of the sample historical gas usage data, the data amount of the sample future gas usage data, the sample type and count of users, and the standard deviation of the sample historical gas usage data are input into the accuracy prediction layer 320-2. The accuracy of the future gas usage data is obtained after processing by the accuracy prediction layer 320-2. The loss function is constructed based on the accuracy of the sample future gas usage data and the accuracy of the future gas usage data output by the accuracy prediction layer 320-2, and the data prediction layer 320-1 and the accuracy prediction layer 320-2 are updated simultaneously. The trained data prediction layer 320-1 and the accuracy prediction layer 320-2 are obtained by parameter updating.

In some embodiments, the first prediction model 320 may be obtained through training based on historical gas usage data, date data, meteorological data, resident population data, trending data and seasonal data of historical gas usage data in historical data. The historical gas usage data, the date data, the meteorological data, the permanent population data, the trending data, and the seasonal data of the historical gas usage data in the historical data may be used as training samples. The labels of the training samples may be calculated by the formula w=1−|n−m|/m. w represents the label, n represents the future gas usage data predicted by the data prediction layer 320-1, and m represents the actual value of the future gas usage data of the historical data. The label is a real number between 0 and 1. For example, if it is Jan. 1, 2030 at present, n may be the gas usage data between Jan. 1, 2029 and Jan. 31, 2029 predicted by the data prediction layer 320-1 based on relevant data between Jan. 1, 2025 and Jan. 1, 2028. m may be the actual gas usage data between Jan. 1, 2029 and Jan. 31, 2029.

In some embodiments of the present disclosure, the accuracy of the future gas usage data is obtained by processing the relevant data using the first prediction model that includes a data prediction layer and an accuracy prediction layer, which is advantageous to solve the problem of difficulty in obtaining labels when training the accuracy prediction layer alone. Secondly, the joint training of the data prediction layer and accuracy prediction layer not only reduces the number of needed samples but also improves the training efficiency. The determining the accuracy of future gas usage data is beneficial to subsequently determine a more accurate gas storage optimization method.

FIG. 5 is a schematic diagram illustrating a process for determining a gas storage optimization method based on a second prediction model according to some embodiments of the present disclosure.

In some embodiments, the supply amount of gas storage and supply method of the target area may be determined based on the gas storage demand data, the accuracy of future gas usage data, the seasonal data, and the cost per unit of gas storage for at least one storage method. More details of determining the amount of gas storage supply and supply method of the target area may be found in FIG. 2 and the related descriptions thereof.

In some embodiments, the smart gas management platform may further determine the amount of gas storage supply, the supply method, and the supply time of the target area through a second prediction model based on the gas storage demand data, the accuracy of the future gas usage data, the seasonal data of the historical gas usage data, and the cost per unit of gas storage for at least one gas storage method. The second prediction model is a machine learning model.

In some embodiments, the second prediction model may be configured to predict the population activity of a preset area at a future moment. The second prediction model may be a machine learning model. For example, a DNN model, CNN model, RNN model, or the like, or any combination thereof.

In some embodiments, as shown in FIG. 5, the input of the second prediction model 520 may include gas storage demand data 510-1, the accuracy of future gas usage data 510-2, the seasonal data of historical gas usage data 510-3, and cost per unit of gas storage for at least one gas storage method 510-4. More details regarding the gas storage demand data, the accuracy of future gas usage data, and the seasonal data of historical gas usage may be found in FIGS. 2-4 and the related descriptions thereof.

In some embodiments, the output of the second prediction model 520 may include a supply amount of gas storage 530-1 and a supply method of gas storage 530-2. In some embodiments, the output of the second prediction model 520 may further include a supply time of gas storage 530-3. The supply time of gas storage may refer to a specific time when the gas storage needs to be replenished. More details regarding the supply amount of gas storage and the supply method of gas storage may be found in FIG. 2 and the related descriptions thereof.

For example, the gas storage demand data 510-1 may be the amount of gas storage needed in neighborhood A for the future week as C m³; the accuracy of the future gas usage data 510-2 may be [90%, 95%, 89%, 92%, 90%, 87%, 96%]; the seasonal data of the historical gas usage data 510-3 may be [a, b, c, d, e, f, g], where a, b, c, d, e, f, g, e, f, and g represents seasonal data for each day of the previous week, respectively. The cost per unit of gas storage for at least one gas storage method 510-4 may be [h, i, g, k, and 1], where h is the unit gas storage cost for gas storage in hydrate form, i is the unit gas storage cost for gas storage in underground storage, g is the unit gas storage cost for gas storage in storage tanks, k is the unit gas storage cost for gas storage in high-pressure pipelines, and l is the unit gas storage cost for liquefied gas storage. Therefore, the corresponding output may be the supply amount of gas storage 530-1 as D m³, the supply method of gas storage 530-2 as gas storage in hydrate form, and the supply time of gas storage 530-3 as M h.

In some embodiments, the second prediction model 520 may be obtained by training a plurality of training samples with labels. A plurality of second training samples 540 with labels may be the input of the second initial model 550, and a loss function is constructed from the labels and the output results of the second initial model 550, and the parameters of the second initial model 550 are updated iteratively based on the loss function. The model training is completed when the loss function of the second initial model 550 meets a preset condition, and the trained second prediction model 520 is obtained. The preset condition may be the convergence of the loss function, the count of iterations reaching a threshold, etc.

In some embodiments, the second training sample 540 may include the sample gas storage demand data, the accuracy of the sample future gas usage data, the seasonal data of the sample historical gas usage data, and the cost per unit of gas storage for at least one sample gas storage method. The labels may include the actual determined optimal sample supply amount of gas storage, and the sample gas storage supply method. In some embodiments, the sample gas storage demand data, the accuracy of the sample future gas usage data, the seasonal data of the sample historical gas usage data, and the cost per unit of gas storage for the at least one sample gas storage method may be obtained based on historical data. The labels may be obtained by manual labeling. The future moment corresponding to the accuracy of the sample future gas usage data is a future moment relative to the sample moment, which is a moment in the historical data. More descriptions regarding the unit gas storage cost for the gas storage method may be found in FIG. 2 and the related descriptions thereof.

When the output of the second prediction model 520 includes the supply time of gas storage 530-3, the label of the second training sample 540 may further include the sample supply time of gas storage. The sample supply time of gas storage may be obtained by manual labeling.

In some embodiments of the present disclosure, the smart gas management platform can quickly and accurately predict the supply amount of gas storage, the supply method, and the supply time of the target area through the second prediction model based on the gas storage demand data, the accuracy of future gas usage data, the seasonal data of historical gas usage data, and the cost per unit of gas storage for at least one gas storage method, thereby conducting to dispatching gas more accurately, alleviating the problem of imbalance between gas supply and demand, and reducing gas storage costs as much as possible while satisfying users' gas usage.

The present disclosure provides a non-transitory computer-readable storage medium that stores computer instructions, when the computer instructions are executed by a processor, the smart gas storage optimization is implemented.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements, and amendments to the present disclosure. These alterations, improvements, and modifications are intended to be suggested by this disclosure and are within the spirit and scope of the exemplary embodiments of this disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for smart gas storage optimization, implemented based on an Internet of Things system for smart gas storage optimization, wherein the Internet of Things system includes a smart gas management platform, a smart gas sensor network platform, and a smart gas object platform that interact in sequence, and the method is executed by the smart gas management platform, comprising:
obtaining gas supply data and historical gas usage data of a target area through the smart gas sensor network platform based on the smart gas object platform;
predicting future gas usage data of the target area based on the historical gas usage data;
determining gas storage demand data of the target area based on the future gas usage data and the gas supply data; and
determining a gas storage optimization method of the target area based on the gas storage demand data.

2. The method of claim 1, wherein the Internet of Things system further includes a smart gas user platform and a smart gas service platform that interact in sequence.

3. The method of claim 1, wherein the smart gas management platform includes a smart running management sub-platform and a smart gas data center, the smart running management sub-platform interacts with the smart gas data center bidirectionally, and the smart running management sub-platform obtains data from the smart gas data center and feeds back management operation running data;
the smart gas object platform includes a gas indoor device object sub-platform and a gas pipe network device object sub-platform, wherein the gas indoor device object sub-platform corresponds to an indoor gas device and the gas pipe network device object sub-platform corresponds to a pipe network gas device; and
the smart gas sensor network platform includes a gas indoor device sensor network sub-platform and a gas pipe network device sensor network sub-platform, wherein the gas indoor device sensor network sub-platform corresponds to the gas indoor device object sub-platform and the gas pipe network device sensor network sub-platform corresponds to the gas pipe network device object sub-platform.

4. The method of claim 1, wherein the predicting future gas usage data of the target area based on the historical gas usage data includes:
predicting the future gas usage data of the target area through a first prediction model based on the historical gas usage data, wherein the first prediction model is a machine learning model.

5. The method of claim 4, wherein an input of the first prediction model further includes date data, meteorological data of the target area, and resident population data of the target area.

6. The method of claim 4, wherein an input of the first prediction model further includes trending data and seasonal data of the historical gas usage data, and the trending data and the seasonal data are obtained based on a decomposition of the historical gas usage data.

7. The method of claim 4, wherein the first prediction model further includes a data prediction layer and an accuracy prediction layer;
an input of the data prediction layer includes the historical gas usage data, date data, meteorological data of the target area and resident population data of the target area, trending data and seasonal data of the historical gas usage data, and an output of the data prediction layer includes the future gas usage data; and
an input of the accuracy prediction layer includes the future gas usage data, a data amount of the historical gas usage data, a data amount of the future gas usage data, a type and count of users, and a standard deviation of the historical gas usage data, and an output of the accuracy prediction layer includes accuracy of the future gas usage data.

8. The method of claim 1, wherein the determining gas storage demand data of the target area based on the future gas usage data and the gas supply data includes:
determining the gas storage demand data of the target area based on a difference between the future gas usage data and the gas supply data.

9. The method of claim 1, wherein the determining gas storage demand data of the target area based on the future gas usage data and the gas supply data includes:
obtaining gas difference data based on a difference between the future gas usage data and the gas supply data; and
determining, based on the gas difference data and a reserve coefficient, the gas storage demand data of the target area.

10. The method of claim 1, wherein the determining a gas storage optimization method of the target area based on the gas storage demand data includes:
determining a supply amount of gas storage and a supply method of the target area based on the gas storage demand data, accuracy of the future gas usage data, seasonal data of the historical gas usage data, and a cost per unit of gas storage for at least one gas storage method.

11. The method of claim 10, wherein the determining an amount of gas storage and a supply method of the target area based on the gas storage demand data, accuracy of the future gas usage data, seasonal data of the historical gas usage data, and a cost per unit of gas storage for at least one gas storage method includes:
determining the supply amount of gas storage, the supply method, and supply time of the target area through a second prediction model based on the gas storage demand data, the accuracy of the future gas usage data, the seasonal data of the historical gas usage data, and the cost per unit of gas storage for at least one storage method, wherein the second prediction model is a machine learning model.

12. An Internet of Things system for smart gas storage optimization, wherein the Internet of Things system comprises a smart gas management platform, a smart gas sensor network platform, and a smart gas object platform that interact in sequence, wherein the smart gas management platform is configured to:
obtain gas supply data and historical gas usage data of a target area through the smart gas sensor network platform based on the smart gas object platform;
predict future gas usage data of the target area based on the historical gas usage data;
determine gas storage demand data of the target area based on the future gas usage data and the gas supply data; and
determine a gas storage optimization method of the target area based on the gas storage demand data.

13. The Internet of things system of claim 12, wherein the Internet of things system further includes a smart gas user platform and a smart gas service platform that interact in sequence.

14. The Internet of Things system of claim 12, wherein the smart gas management platform includes a smart running management sub-platform and a smart gas data center, the smart running management sub-platform interacts with the smart gas data center bidirectionally, and the smart running management sub-platform obtains data from the smart gas data center and feeds back management operation running data;
the smart gas object platform includes a gas indoor device object sub-platform and a gas pipe network device object sub-platform, wherein the gas indoor device object sub-platform corresponds to an indoor gas device and the gas pipe network device object sub-platform corresponds to a pipe network gas device; and
the smart gas sensor network platform includes a gas indoor device sensor network sub-platform and a gas pipe network device sensor network sub-platform, wherein the gas indoor device sensor network sub-platform corresponds to the gas indoor device object sub-platform and the gas pipe network device sensor network sub-platform corresponds to the gas pipe network device object sub-platform.

15. The Internet of Things system of claim 12, wherein to predict future gas usage data of the target area based on the historical gas usage data, the smart gas management platform is further configured to:
predict the future gas usage data of the target area through a first prediction model based on the historical gas usage data, wherein the first prediction model is a machine learning model.

16. The Internet of Things system of claim 15, wherein an input of the first prediction model further includes date data, meteorological data of the target area, and resident population data of the target area.

17. The Internet of Things system of claim 15, wherein an input of the first prediction model further includes trending data and seasonal data of the historical gas usage data, and the trending data and the seasonal data are obtained based on a decomposition of the historical gas usage data.

18. The Internet of Things system of claim 15, wherein the first prediction model further includes a data prediction layer and an accuracy prediction layer;
an input of the data prediction layer includes the historical gas usage data, date data, meteorological data of the target area and resident population data of the target area, trending data and seasonal data of the historical gas usage data, and an output of the data prediction layer includes the future gas usage data; and
an input of the accuracy prediction layer includes the future gas usage data, a data amount of the historical gas usage data, a data amount of the future gas usage data, a type and count of users, and a standard deviation of the historical gas usage data, and an output of the accuracy prediction layer includes accuracy of the future gas usage data.

19. The Internet of Things system of claim 12, wherein to determine gas storage demand data of the target area based on the future gas usage data and the gas supply data, the smart gas management platform is further configured to:
determine the gas storage demand data of the target area based on a difference between the future gas usage data and the gas supply data.

20. A non-transitory computer-readable storage medium storing computer instructions, wherein when the computer instructions are executed by a processor, the method of claim 1 is implemented.
